(19) United States
(12) Patent Application Publication
(10) Pub. No.: US 2004/0228762 A1
(43) Pub. Date: Nov. 18, 2004

(54) Kit for evaluating dental caries activity

(75) Inventors: Yuko Matsumoto, Tokyo (JP); Junichi Okada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: GC Corporation, Tokyo (JP)

(21) Appl. No.: 10/429,767

(22) Filed: May 6, 2003

(51) Int. Cl. G01N 1/00

(52) U.S. Cl. 422/61

(57) ABSTRACT

Evaluation of dental caries activity, i.e., the released amount of an acid from dental plaque can be made in a simple manner in a short time by using a kit for evaluating dental caries activity, in which a pH indicator having an indicator range of pH 3.5 to 8.0 and a sugar are carried on or impregnated in an absorptive material of the kit, a pH value of the absorptive material before evaluation test is adjusted to be higher than the indicator range of the pH indicator, and dental plaque taken from a subject is directly applied thereon, and dental caries activity is evaluated with change of color of the absorptive material.

### BACKGROUND OF THE INVENTION

1. Field of the Invention

The present invention relates to a kit for evaluating dental caries activity capable of evaluating activity of dental caries in an oral cavity of a subject by a simple manner in a short period of time.

2. Description of Conventional Art

Evaluation of dental caries activity in dental surgery is to estimate and determine activity of dental caries, i.e., as to whether or not dental caries of teeth currently developed proceeds, and as to whether or not there is a possibility of development of dental caries due to activity of dental caries while no dental caries is currently developed. Therefore, it has great significance in dental health.

It is considered that development and progress of dental caries of teeth are caused in such mechanisms referred to as a decalcifying phenomenon that cariogenic bacteria present in dental plaque attached to the teeth metabolize carbohydrate to produce an acid, and calcium ions and phosphoric ions in the teeth are eluted by the acid. Therefore, a method of measuring a released amount of an acid from dental plaque is studied as a method for evaluating dental caries activity. Because it is considered that the released amount of an acid from dental plaque depends on the number of cariogenic bacteria present in the dental plaque, such a method is carried out by a measuring test for the number of mutans streptococcus in the dental plaque and a measuring test for the number of lactobacilli in the dental plaque. However, these methods have such disadvantages that expensive culturing equipments, sophisticated operation techniques and prolonged culturing periods are required.

Under the circumstances, various methods capable of evaluating in simple manners have been proposed (for example, as disclosed in JP-A-50-1589, JP-A-54-47700, JP-A-56-96700, JP-A-56-120623, JP-B-57-13824 and JP-A-59-99354). These methods each include such a process that dental plaque taken from teeth of a subject is added to an aqueous solution containing a pH indicator and a sugar, and the released amount of an acid is then evaluated by the change in color shown by the pH indicator in the aqueous solution. These are excellent in simpleness in comparison to the conventional method for measuring number of bacteria because the dental caries activity can be evaluated only by adding the dental plaque into the aqueous solution.

However, these methods have such disadvantages that because it is necessary to add the dental plaque to the aqueous solution, the dental plaque is dispersed in the aqueous solution to dilute the acid produced by the cariogenic bacteria in the dental plaque, and therefore, a prolonged period of time from the addition of the dental plaque, such as 30 minutes to 48 hours, is required for the change in color shown by the pH indicator to require a long period of time for the evaluation.

### SUMMARY OF THE INVENTION

An object of the present invention is to solve the problems associated with the conventional techniques and to provide a kit for evaluating dental caries activity capable of evaluating activity of dental caries of a subject, i.e., a released amount of an acid from dental plaque, by a simple manner in a short period of time.

As a result of earnest investigations made by the inventors for solving the problems, it has been found that when dental plaque taken from a subject is directly applied on such an absorptive material that has a particular pH indicator and a sugar impregnated therein or carried thereon and is in a state where a pH value exhibited by the absorptive material is higher than an indicator range of the particular pH indicator, instead of the conventional evaluation requiring cultivation in an aqueous solution, an acid produced in the dental plaque is not diluted, and therefore, the pH indicator sensitively responds thereto in a short period of time to cause change in color. Accordingly, the evaluation can be carried out by observation of change in color in a short period, since it is not necessary to observe change in color of the pH indicator after cultivation consuming a long period of time. Thus, the present invention has been completed.

The present invention relates to:

(1) as a first aspect, a kit for evaluating dental caries activity containing an absorptive material having carried thereon a pH indicator having an indicator range of pH 3.5 to 8.0, and an aqueous solution containing a sugar, the absorptive material, upon impregnated with a prescribed amount of the aqueous solution, exhibiting a pH value higher than the indicator range of the pH indicator, in which dental plaque taken from a subject is directly applied on the material having been impregnated with the prescribed amount of the aqueous solution, or dental plaque taken from a subject is directly applied on the material, which is then impregnated with the prescribed amount of the aqueous solution, so as to evaluate dental caries activity with change of color of the absorptive material; and

(2) as a second aspect, a kit for evaluating dental caries activity containing an absorptive material and an aqueous solution containing a pH indicator having an indicator range of pH 3.5 to 8.0 and a sugar, the absorptive material, upon impregnated with a prescribed amount of the aqueous solution, exhibiting a pH value higher than the indicator range of the pH indicator, in which dental plaque taken from a subject is directly applied on the material having been impregnated with the prescribed amount of the aqueous solution, or dental plaque taken from a subject is directly applied on the material, which is then impregnated with the prescribed amount of the aqueous solution, so as to evaluate dental caries activity with change of color of the absorptive material.

It is preferred in the present invention that the pH indicator used in the kit for evaluating dental caries activity is selected from the group consisting of p-ethoxychrysoidine, α-naphthyl red, alizarine sodium sulfonate, bromo cresol green, methyl red, 2,5-dinitrophenol, p-nitrophenol, azolitmin, bromo cresol purple, bromo phenol red, chloro phenol red, phenol red, m-nitrophenol, neutral red, rosolic acid, bromo thymol blue, china blue, lacmoid and resazurin, and it is also preferred that the sugar is selected from the group consisting of glucose, sucrose, fructose, lactose, maltose, an isomerized sugar, isomaltooligosaccharide, panoseoligosaccharide, starch syrup and a coupling sugar.

### DESCRIPTION OF THE PREFERRED EMBODIMENTS

The absorptive material used in the kit for evaluating dental caries activity of the present invention is not particularly limited, as far as it exhibits a pH value higher than the indicator range of the pH indicator in such a state that the absorptive material is impregnated with or carries the particular pH indicator and the sugar. Paper, such as filter paper, absorbent paper and paper towel, is most preferred, and also cloth and nonwoven cloth formed with fibers, such as absorbent cotton, silica wool, glass wool, wool, silk, cotton, linen, acrylic fibers, rayon, nylon, nitrocellulose, cellulose acetate, regenerated cellulose and glass fibers, can also be used. Furthermore, a material formed by molding dextran, mutan, levan or cellulose powder can also be used. In the case where the material does not indicate a pH value higher than the indicator range of the pH indicator even when the material is impregnated with or carries the particular pH indicator and the sugar, an alkaline liquid is previously carried thereon, or an alkaline liquid is previously mixed with the pH indicator or the sugar to be impregnated. The shape of the absorptive material is preferably a sheet form having a substantial square planar shape with an edge length of 0.3 to 30 cm or a substantial circular planar shape with a diameter of 0.3 to 30 cm with a thickness of 0.2 to 2 mm, and is more preferably a sheet form having a substantial square planar shape with an edge length of 0.3 to 8 cm or a substantial circular planar shape with a diameter of 0.3 to 8 cm. It is further preferably a sheet form having a substantial square planar shape with an edge length of 0.3 to 2 cm or a substantial circular planar shape with a diameter of 0.3 to 2 cm from the standpoint that dental plaque, which is difficult to be taken in a large amount, is directly applied thereon.

The pH indicator used in the kit for evaluating dental caries activity according to the present invention is not particularly limited as far as it has an indicator range in a range of pH 3.5 to 8.0, and examples thereof include p-ethoxychrysoidine (indicator range: 3.8 to 5.4), α-naphthyl red (indicator range: 3.7 to 5.0), alizarine sodium sulfonate (indicator range: 5.5 to 6.8), bromo cresol green (indicator range: 3.8 to 5.9), methyl red (indicator range: 4.4 to 6.2), 2,5-dinitrophenol (indicator range: 4.0 to 5.8), p-nitrophenol (indicator range: 5.0 to 7.0), azolitmin (indicator range: 5.0 to 8.0), bromo cresol purple (indicator range: 5.2 to 6.8), bromo phenol red (indicator range: 5.2 to 7.0), chloro phenol red (indicator range: 5.2 to 6.8), phenol red (indicator range: 6.4 to 8.0), m-nitrophenol (indicator range: 6.4 to 8.8), neutral red (indicator range: 6.8 to 8.0), rosolic acid (indicator range: 6.8 to 8.0), bromo thymol blue (indicator range: 6.0 to 7.6), china blue (indicator range: 2.8 to 8.0), lacmoid (indicator range: 4.4 to 6.4) and resazurin (indicator range: 3.8 to 6.5). These pH indicators may be used by mixing two or more kinds of them. When the concentration of the pH indicator is too small, the change in color is unintelligible, whereas when it is too large, a prolonged time is required for the change in color, and the color tone becomes dark to make the change in color unintelligible. Specifically, in the case where the pH indicator is used in the form of an aqueous solution as the kit for evaluating dental caries activity, the concentration thereof in a solvent having no influence on cariogenic bacteria and no buffering function, such as water, is preferably from 0.001 to 10% by weight, and more preferably 0.05 to 10% by weight. In the case where the pH indicator is used in a dried state carried on the absorptive material, the amount thereof is preferably about 0.001 to 0.5% by weight, and more preferably 0.005 to 0.03% by weight, based on the weight of the absorptive material.

The sugar used in the kit for evaluating dental caries activity according to the present invention is not particularly limited as far as cariogenic bacteria can produce an acid through metabolism therewith, and usable examples thereof include glucose, sucrose, fructose, lactose, maltose, an isomerized sugar, isomaltooligosaccharide, panoseoligosaccharide, starch syrup and a coupling sugar. When the concentration of the sugar is too small, the pH indicator does not suffer change in color in a short period of time due to a small amount of an acid produced by cariogenic bacteria, whereas when it is too large, cariogenic bacteria receive an osmotic pressure to affect development of an acid. Specifically, upon using in the form of an aqueous solution in the kit for evaluating dental caries activity, the concentration thereof in a solvent having no influence on cariogenic bacteria and no buffering function, such as water, is preferably 2 to 60% by weight, and more preferably 5 to 40% by weight.

In the case where the kit for evaluating dental caries activity according to the present invention contains an absorptive material having the particular pH indicator carried thereon, and an aqueous solution containing the sugar, it is necessary that the absorptive material having the particular pH indicator carried thereon and/or the aqueous solution of the sugar are adjusted in pH value with a sodium hydroxide aqueous solution or a potassium hydroxide aqueous solution, whereby the pH value upon impregnation of the absorptive material with a prescribed amount of the aqueous solution containing the sugar is higher than the indicator range of the particular pH indicator. In the case where the kit for evaluating dental caries activity according to the present invention contains an absorptive material and an aqueous solution containing the particular pH indicator and the sugar, it is necessary that the absorptive material and/or the aqueous solution containing the particular pH indicator and the sugar are adjusted in pH value with a sodium hydroxide aqueous solution or a potassium hydroxide aqueous solution, whereby the pH value upon impregnation of the absorptive material with a prescribed amount of the aqueous solution containing the particular pH indicator and the sugar is higher than the indicator range of the particular pH indicator. The pH value can be adjusted in such a manner that the absorptive material is impregnated or sprayed with a sodium hydroxide aqueous solution or a potassium hydroxide aqueous solution, or in alternative, the pH value of the aqueous solution containing the sugar or the aqueous solution containing the particular pH indicator and the sugar is adjusted. The pH value is preferably adjusted to be higher than an estimated pH value of dental plaque.

A using method of the kit for evaluating dental caries activity according to the present invention will be described. In the case of the kit for evaluating dental caries activity according to the first aspect, the absorptive material having carried thereon a pH indicator having an indicator range of pH 3.5 to 8.0 is impregnated with a prescribed amount of the aqueous solution containing the sugar by such a method as dropping, and then dental plaque taken from a subject is directly applied thereon, or in alternative dental plaque taken from a subject is directly applied on the absorptive material having carried thereon a pH indicator having an indicator range of pH 3.5 to 8.0, and then the absorptive material is impregnated with a prescribed amount of the aqueous solution containing the sugar by such a method as dropping. Thereafter, change in color shown by the absorptive material is observed after lapsing a prescribed period of time. In the case of the kit for evaluating dental caries activity according to the second aspect, the absorptive material is impregnated with a prescribed amount of the aqueous solution containing the pH indicator having an indicator range of pH 3.5 to 8.0 and the sugar by such a method as dropping, and then dental plaque taken from a subject is directly applied thereon, or in alternative dental plaque taken from a subject is directly applied on the absorptive material, and then the absorptive material is impregnated with a prescribed amount of the aqueous solution containing the pH indicator having an indicator range of pH 3.5 to 8.0 and the sugar by such a method as dropping. Thereafter, change in color shown by the absorptive material is observed after lapsing a prescribed period of time.

Cariogenic bacteria present in the dental plaque applied on the absorptive material produces an acid through metabolism with the sugar contained in the absorptive material to lower the pH of the absorptive material, and when the pH runs over the indicator range of the pH indicator, the color of the absorptive material is changed and thus is observed. The color shown by the absorptive material after lapsing a prescribed period of time varies with respect to the amount of the acid produced by the cariogenic bacteria through metabolism with the sugar, and the amount of the acid depends on the number of the cariogenic bacteria present in the plaque. Therefore, the dental caries activity of the subject can be evaluated by observing the color shown by the kit for evaluating dental caries activity after lapsing the prescribed period of time.

In the case where, upon using the kit for evaluating dental caries activity according to the present invention, dental plaque taken from a subject is directly applied on such the absorptive material having the pH indicator having an indicator range of pH 3.5 to 8.0 before impregnation with the aqueous solution containing the sugar, and then the absorptive material is impregnated with the aqueous solution containing the sugar by such a method as dropping, followed by observing the color change of the kit for evaluating dental caries activity after lapsing the prescribed period of time, it is also possible to carry out two-step evaluation, in which the pH value of the dental plaque itself can be confirmed, and the amount of the acid produced through metabolism with the sugar.

Such an operation can also be considered that the sugar is previously carried on an absorptive material, and an aqueous solution containing the pH indicator is dropped thereon before or after coating dental plaque taken from a subject. However, it is not preferred because not only the accuracy of evaluation is decreased, but also the operation of evaluation becomes complicated. As a using method of the kit for evaluating dental caries activity according to the present invention, another operation can also be considered that an oral cavity of a subject is washed with an aqueous solution containing the sugar, and then dental plaque of the subject is taken and applied on an absorptive material having the pH indicator carried thereon. However, it is not practical because the mouthwash with the aqueous solution containing the sugar brings about necessity of further mouthwash, for example, with toothpaste.

Upon using the kit for evaluating dental caries activity according to the present invention, the color shown by the kit for evaluating dental caries activity after lapsing the prescribed period of time varies depending on the kind of the pH indicator used. For example, the color changes, in an order from a higher pH value to a lower value, from blue, magenta to pink for resazurin, from blue, magenta to pink for lacmoid, from yellow, pink to red for methyl red, from blue, green to yellow for bromo thymol blue, and from purple, greenish yellow to yellow for bromo cresol purple.

### EXAMPLES

The present invention will be further described, but the present invention is not construed as being limited thereto.

Production of Kit for Evaluating Dental Caries Activity

Filter paper in a square form having a width of 10 mm, a length of 10 mm and a thickness of 0.38 mm (Filter Paper 3, a trade name, produced by WHATMAN Inc.) was prepared as an absorptive material and was impregnated with the aqueous solution containing a pH indicator (1) or (2) prepared according to the composition shown in Table 1. The filter paper was then taken out and dried to form absorptive materials of kits for evaluating dental caries activity 1 and 2. Aqueous solutions containing a sugar (1) and (2) were prepared according to the composition shown in Table 1 to form aqueous solutions of the kits for evaluating dental caries activity 1 and 2. The absorptive materials having not been treated were used as absorptive materials of kits for evaluating dental caries activity 3 and 4, and mixed solutions (3) and (4) obtained by mixing aqueous solutions containing a pH indicator (3) or (4) and aqueous solutions containing a sugar (3) and (4), respectively, were used as aqueous solutions of kits for evaluating dental caries activity 3 and 4.

Evaluation Method for Dental Caries Activity

Two subjects, subject A and subject B, were evaluated for dental caries activity by using the kits for evaluating dental caries activity 1 to 4 in the following ways. In the case of the kit for evaluating dental caries activity 1, after impregnating the absorptive material with the aqueous solution containing a sugar (1) by dropping, about 1 mg of dental plaque taken from the two subjects is directly applied thereon. The material was then allowed to stand at room temperature for 5 minutes, and the colors shown by the absorptive material was observed. In the case of the kit for evaluating dental caries activity 2, after applying about 1 mg of dental plaque taken from the two subjects on the absorptive material, the absorptive material is impregnated with the aqueous solution containing a sugar (2) by dropping. The material was then allowed to stand at room temperature for 5 minutes, and the colors shown by the absorptive material was observed. In the case of the kit for evaluating dental caries activity 3, after impregnating the absorptive material with the mixed solution (3) by dropping, about 1 mg of dental plaque taken from the two subjects is directly applied thereon. The material was then allowed to stand at room temperature for 5 minutes, and the colors shown by the absorptive material was observed. In the case of the kit for evaluating dental caries activity 4, after applying about 1 mg of dental plaque taken from the two subjects on the absorptive material, the absorptive material is impregnated with the mixed solution (4) by dropping. The material was then allowed to stand at room temperature for 5 minutes, and the colors shown by the absorptive material was observed. The results of evaluation are shown in Table 1.

TABLE 1
(Unit: percent by weight)

| | | | Aqueous | Aqueous | Aqueous | Aqueous |
|---|---|---|---|---|---|---|
| | | | solution (1) | solution (2) | solution (3) | solution (4) |
| Aqueous | Concentration | Bromo cresol | 0.005 | — | 0.05 | — |
| solution | | purple | | | | |
| containing | | Resazurin | — | 0.005 | — | 0.1 |
| pH indicator | | Water* | balance | balance | balance | balance |
| Aqueous | Concentration | Sucrose | — | — | 5 | — |
| solution | | Glucose | 5 | — | — | 10 |
| containing | | Lactose | — | 10 | — | — |
| sugar | | Water* | balance | balance | balance | balance |
| Absorptive | pH indicator | Bromo cresol | 0.01 | — | — | — |
| material | | Purple | | | | |
| | | (purple [symbol] | | | | |
| | | greenish | | | | |
| | | yellow [symbol] | | | | |
| | | yellow) | | | | |
| | | Resazurin | — | 0.01 | — | — |
| | | (blue [symbol] | | | | |
| | | magenta [symbol] | | | | |
| | | pink) | | | | |

| | | | | | | | | | |
|---|---|---|---|---|---|---|---|---|---|
| Evaluation results of | Subject | A | B | A | B | A | B | A | B |
| dental caries activity | Color before | purple | purple | blue | blue | purple | purple | blue | blue |
| | evaluation | | | | | | | | |
| | Color after | yellow | greenish | pink | magenta | yellow | greenish | pink | magenta |
| | lapsing 5 min | | yellow | | | | yellow | | |

Water absorbing amount of filter paper: abt. 50 mg, weight of filter paper: 25.3 mg
Water*: Aqueous solution of sodium hydroxide having pH adjusted to 7.2

It was understood from the results that the dental caries activity of the subject A is higher than the dental caries activity of the subject B. As results of an actual measurement of the number of mutans streptococcus in about 1 mg of dental plaque, it was 1×10⁶ CFU for the subject A and 1×10⁵ CFU for the subject B. The evaluation was carried out by the comparison between the subjects in the example. However, the kit for evaluating dental caries activity according to the present invention can accurately evaluates the activity of dental caries with a simple operation instead of relative evaluation by previously determining the pH caused by the activity of bacteria and the number of cariogenic bacteria in the dental plaque upon using a kit for evaluating dental caries activity prepared under prescribed conditions.

As described in the foregoing, by using the kit for evaluating dental caries activity according to the present invention, dental caries activity, i.e., the released amount of an acid from dental plaque, which is important in dental health, can be evaluated by a simple manner in a short period of time. Furthermore, the potency in evaluation of dental caries activity thereof can be variously changed by kinds and amounts of the pH indicator and the sugar used and by the pH value adjusted to a higher value than the indicator range of the pH indicator. Thus, the present invention contributes the dental field to exert a significant value.

What is claimed is:

1. A kit for evaluating dental caries activity comprising an absorptive material having carried thereon a pH indicator having an indicator range of pH 3.5 to 8.0, and an aqueous solution containing a sugar, the absorptive material, upon impregnated with a prescribed amount of the aqueous solution, exhibiting a pH value higher than the indicator range of the pH indicator, in which dental plaque taken from a subject is directly applied on the material having been impregnated with the prescribed amount of the aqueous solution, or dental plaque taken from a subject is directly applied on the material, which is then impregnated with the prescribed amount of the aqueous solution, so as to evaluate dental caries activity with change of color of the absorptive material.

2. A kit for evaluating dental caries activity comprising an absorptive material, and an aqueous solution containing a pH indicator having an indicator range of pH 3.5 to 8.0 and a sugar, the absorptive material, upon impregnated with a prescribed amount of the aqueous solution, exhibiting a pH value higher than the indicator range of the pH indicator, in which dental plaque taken from a subject is directly applied on the material having been impregnated with the prescribed amount of the aqueous solution, or dental plaque taken from a subject is directly applied on the material, which is then impregnated with the prescribed amount of the aqueous solution, so as to evaluate dental caries activity with change of color of the absorptive material.

3. A kit for evaluating dental caries activity as claimed in claim 1 or 2, wherein the pH indicator is one or more selected from the group consisting of p-ethoxychrysoidine, α-naphthyl red, alizarine sodium sulfonate, bromo cresol green, methyl red, 2,5-dinitrophenol, p-nitrophenol, azolitmin, bromo cresol purple, bromo phenol red, chloro phenol red, phenol red, m-nitrophenol, neutral red, rosolic acid, bromo thymol blue, china blue, lacmoid and resazurin.

4. A kit for evaluating dental caries activity as claimed in one of claims 1 to 3, wherein the sugar is one or more selected from the group consisting of glucose, sucrose, fructose, lactose, maltose, an isomerized sugar, isomaltooligosaccharide, panoseoligosaccharide, starch syrup and a coupling sugar.
